(19) United States
(12) Patent Application Publication
(10) Pub. No.: US 2023/0409782 A1
(43) Pub. Date: Dec. 21, 2023

(54) METHOD AND SYSTEM FOR CONSTRUCTING DIGITAL TWIN OF COOKING TARGET LINKED WITH KITCHEN APPLIANCE

(71) Applicant: SIMACRO, Seoul (KR)

(72) Inventors: Jeong-Ho YUN, Lexington, MA (US); Eric LIU, Arlington, MA (US); Wangsoo KIM, Seoul (KR); Elijah PARK, Seoul (KR); Joungok KO, Seoul (KR)

(21) Appl. No.: 18/242,522

(22) Filed: Sep. 6, 2023

Related U.S. Application Data
(63) Continuation of application No. PCT/KR2021/007535, filed on Jun. 16, 2021.
(60) Provisional application No. 63/196,206, filed on Jun. 2, 2021.

(30) Foreign Application Priority Data
Jun. 11, 2021 (KR) 10-2021-0075861

(51) Int. Cl. G06F 30/27

(52) U.S. Cl. CPC G06F 30/27; G06F 2111/10

(57) ABSTRACT

A method for constructing a digital twin of a cooking target linked with kitchen appliances according to the present invention comprises the steps of: allowing a digital twin system to receive target cooking condition data and real-time cooking target data from kitchen appliances; allowing the digital twin system to materialize digital twin simulation based on the received target cooking condition data and real-time cooking target data; allowing the digital twin system to receive input data required for heat transfer simulation from a machine learning module; and allowing the digital twin system to estimate an internal temperature value for monitoring a cooking process of the cooking target in real time.

### CROSS-REFERENCE TO RELATED APPLICATION

This application is a US Bypass Continuation Application of International Application No. PCT/KR2021/007535, filed on Jun. 16, 2021, which claims priority to and the benefit of U.S. Patent Provisional Application No. 63/196,206, filed on Jun. 2, 2021, and Korean Patent Application No. 10-2021-0075861, filed on Jun. 11, 2021, the disclosure of which is incorporated herein by reference in its entirety.

### BACKGROUND

### Technical Field

The present invention relates to a method, a program, and a system for constructing a digital twin of a cooking target linked with a kitchen appliance.

### Related Art

A digital twin (hereinafter, referred to as DT) represents a technique of visualizing a physical system in digital form like twins using measurable data. Using DT, not only measurement data but also values calculated through simulation can be directly checked in real time through digital 2D screen or 3D shaping. By digitizing and representing the key variables of the physical system, it is possible to analyze the current state of the system, predict future behavior, and further prevent potential risks such as the explosion of chemical processes. As such, DT plays a role in effectively monitoring, managing, and controlling the system and is also used in factory design, construction, and optimization.

Digital visualization, which is an advantage of DT, has several advantages, particularly in terms of monitoring, measurement, and control, and one of them is that values that cannot be measured easily in the physical system (for example, temperature changes in food over time) can be observed together with the results obtained through simulation. This is particularly useful when an easily unmeasurable value is an important factor in determining the performance capability, such as the efficiency of the system. In addition to the purpose of monitoring the system, DTs help to monitor, manage and control changes in the workflow. Due to these advantages, DT is currently a fusion project between the digital New Deal and the green New Deal of the “Korean version of the New Deal” announced by the Korean government on Jul. 14, 2020, and the importance of the technology is becoming more prominent. Currently, this technology is widely used in urban planning, chemical engineering, etc.

However, the current application field of the digital twin is mainly used in systems that deal with macroscopic processes such as smart factories and continuous processes, and there is a limitation in that systems that can visually check information in people's real life are limited. From this point of view, with the advent of the Fourth Industrial Revolution, development is required to introduce digital twins into the real world domain.

### SUMMARY

### Technical Problem

In order to solve the above-described problems, the present invention is to provide a method and system for constructing a digital twin of a cooking target linked with a kitchen appliance.

The problems to be solved by the present disclosure are not limited to the above-mentioned problems, and other problems not mentioned will be clearly understood by the skilled person in the art from the following description.

### Technical Solution

A method for constructing a digital twin of a cooking target linked with kitchen appliances according to the present invention comprises the steps of: allowing a digital twin system to receive target cooking condition data and real-time cooking target data from kitchen appliances; allowing the digital twin system to materialize digital twin simulation based on the received target cooking condition data and real-time cooking target data; allowing the digital twin system to receive input data required for heat transfer simulation from a machine learning module; and allowing the digital twin system to estimate an internal temperature value for monitoring a cooking process of the cooking target in real time.

The target cooking condition may include at least one temperature data on a surface of a cooking target, a volume of the cooking target, an average radius, and the like, and a physical measurement value of the cooking target.

The step of specifying the digital twin simulation may include the steps of: determining whether real-time cooking target data is collected by a plurality of sensors; reflecting the plurality of real-time data in the construction of the digital twin simulation when the real-time data is collected by the plurality of sensors; and converting the plurality of real-time data into a plurality of data based on the real-time data simulation for a cooking utensil when the real-time data is collected by a single sensor and reflecting the plurality of real-time data in the construction of the digital twin simulation.

The converting into the plurality of data based on the real-time data simulation may further include acquiring characteristic data of the cooking utensil from the outside and generating a simulation.

The reflecting of the plurality of real-time data in the construction of the digital twin simulation may include determining appearance information of the cooking target and determining internal information of the cooking target.

The determining of the appearance information of the cooking target may include determining mass, volume, three-dimensional appearance, and surface temperature distribution of the cooking target.

The determining of the internal information of the cooking target may include determining the internal information based on the identified basic information of the cooking target or determining the internal information based on the basic information of the cooking target input to the customer terminal or the kitchen appliance.

The determining of the internal information of the cooking target may be determining a composition, a density, and a layer structure of the inside of the cooking target.

The step of receiving input data required for the heat transfer simulation may be a step of receiving a variable value required for a heat conduction function.

The variable value required for the heat conduction function may be obtained from a first database obtained through a reverse estimation module.

The method may further include: receiving inappropriate review data based on a deviation between the digital twin simulation and the actual cooking result from a customer terminal or a kitchen appliance; and feedback-updating a variable value required for a heat conduction function of the first database.

The variable value required for the heat conduction function may be obtained from a second database obtained through a customer personalization module.

The method may further include: receiving taste review data based on a cooking state intended by a customer through a customer terminal; and feedback-updating a variable value required for a heat conduction function of the second database.

The variable value required for the heat conduction function may be obtained from a third database obtained through the cooking utensil individualization module.

The method may further include: receiving review data for each cooking utensil based on the deviation for each cooking utensil from the kitchen appliance; and feedback-updating a variable value required for a heat conduction function of the third database.

In the receiving of the input data required for the heat transfer simulation, a variable value required for the heat conduction function may be provided from at least one of a first database obtained through a back estimation module, a second database obtained through a customer personalization module, and a third database obtained through a cooking utensil personalization module, or input data values of the first to third databases may be converted and received in a predetermined manner.

The conversion into the predetermined scheme may be performed based on a first weight applied to the variable value of the first database, a second weight applied to the variable value of the second database, and a third weight applied to the variable value of the third data.

The method may further include, after the estimating of the internal temperature value, requesting the kitchen appliance to complete cooking when the internal temperature of the digital twin reaches the target cooking condition.

According to an embodiment of the present invention, the digital twin system comprises: a transceiver capable of transmitting and receiving information to and from a client terminal, a kitchen appliance, and a machine learning module through a network; a memory for storing an application which provides a function of receiving target condition cooking data from the kitchen appliance, receiving input data from the machine learning module, and forming a digital twin for a cooking target; a processor for reading and controlling the application from the memory; an input unit for receiving a command from a user through the client terminal; and an output unit for outputting a result value according to the control of the processor.

The application may allow the digital twin system to receive target cooking condition data and real-time cooking target data from a kitchen appliance, allow the digital twin system to materialize a digital twin simulation based on the received target cooking condition data and real-time cooking target data, allow the digital twin system to receive input data required for a heat transfer simulation from a machine learning module, and allow the digital twin system to estimate an internal temperature value for monitoring a cooking process of a cooking target in real time.

A digital twin construction program according to an embodiment of the present invention may be combined with hardware, which is a computer, and stored in a medium in order to execute the above-described method.

### Effects of the Invention

The method and system for constructing a digital twin of a cooking target linked with a kitchen appliance according to the present invention can estimate an internal temperature value for monitoring a cooking process of the cooking target in real time based on target cooking condition data and real-time cooking target data.

Specifically, the estimation of the internal temperature value can improve the precision by converting the internal temperature value into a plurality of data based on the real-time data simulation for the cooking utensil and reflecting the plurality of real-time data in the construction of the digital twin simulation.

In the construction of the digital twin, the variable value required for the heat conduction function may be obtained from a first database obtained through a back estimation module, the variable value required for the heat conduction function may be obtained from a second database obtained through a customer personalization module, or the variable value required for the heat conduction function may be obtained from a third database obtained through a cooking utensil personalization module.

The effects of the present invention are not limited to the effects mentioned above, and other effects not mentioned may be clearly understood by the skilled person in the art from the following description.

### BRIEF DESCRIPTION OF THE DRAWINGS

FIG. 1 is a block diagram specifically illustrating a relationship between a digital twin system, a customer terminal, kitchen appliances, and a machine learning module according to the present invention.

FIG. 2 is a flowchart illustrating a method for constructing a digital twin of a cooking target according to the present invention.

FIG. 3 is a flowchart illustrating a process of reflecting a plurality of real-time data in a digital twin simulation.

FIG. 4 is a view illustrating sensing a surface temperature distribution of a cooking target based on a plurality of sensors.

FIG. 5 is a diagram illustrating that the surface temperature distribution of a cooking target is estimated based on a simulation of one sensor and the cooking utensil.

FIG. 6 is a diagram sequentially showing information exchanged between a digital twin system according to the present invention and a customer terminal, a kitchen appliance, and a machine learning module.

FIG. 7 is a diagram illustrating an example of a heat conduction analysis of a cooking target that is cooked in an induction oven.

FIG. 8 is a view illustrating an example of the heat conduction analysis of a cooking target cooked in a microwave oven.

### DETAILED DESCRIPTION

A method for constructing a digital twin of a cooking target linked with kitchen appliances according to the present invention comprises the steps of: allowing a digital twin system to receive target cooking condition data and real-time cooking target data from kitchen appliances; allowing the digital twin system to materialize digital twin simulation based on the received target cooking condition data and real-time cooking target data; allowing the digital twin system to receive input data required for heat transfer simulation from a machine learning module; and allowing the digital twin system to estimate an internal temperature value for monitoring a cooking process of the cooking target in real time.

Hereinafter, exemplary embodiments of the present disclosure will be described in detail with reference to the accompanying drawings. Advantages and features of the present disclosure, and methods of achieving them will become apparent with reference to embodiments described in detail below together with the accompanying drawings. However, the technical spirit of the present disclosure is not limited to the following embodiments, but may be implemented in various different forms, and the following embodiments are provided to complete the technical spirit of the present disclosure and completely inform a person having ordinary skill in the art to which the present disclosure belongs of the scope of the present disclosure, and the technical spirit of the present disclosure is only defined by the scope of Claims.

In adding reference numerals to elements in each drawing, it should be noted that the same elements will be designated by the same reference numerals, if possible, although they are shown in different drawings. In addition, in describing the present disclosure, when it is determined that a detailed description of related known features or functions may obscure the gist of the present disclosure, the detailed description thereof will be omitted.

Unless otherwise defined, all terms (including technical and scientific terms) used herein have the same meaning as commonly understood by one of ordinary skill in the art to which the present disclosure belongs. In addition, terms defined in commonly used dictionaries are not interpreted ideally or excessively unless they are clearly specifically defined. The terminology used herein is for the purpose of describing embodiments and is not intended to limit the present disclosure. In the specification, a singular form includes a plural form unless specifically mentioned in the text.

In addition, in describing the feature element of the present disclosure, terms such as first, second, A, B, (a), (b), and the like may be used. The term is used only to distinguish the feature element from other feature elements, and the nature, sequence, or order of the corresponding feature element is not limited by the term. When a feature element is described as being “connected,” “coupled,” or “connected” to another element, the feature element may be directly connected or connected to the other element, but it should be understood that another feature element may be “connected,” “coupled,” or “connected” between each feature element.

“Comprises” and/or “comprising” used in the present disclosure does not exclude the presence or addition of one or more other feature elements, steps, operations and/or elements in the noted feature elements, steps, operations and/or elements.

A component included in any one embodiment and a feature element including a common function may be described using the same name in another embodiment. Unless otherwise stated, the description described in any one embodiment may be applied to other embodiments, and a detailed description may be omitted within a redundant range or a range that can be clearly understood by a skilled person in the art in the art.

Hereinafter, some embodiments of the present disclosure will be described in detail according to the accompanying drawings.

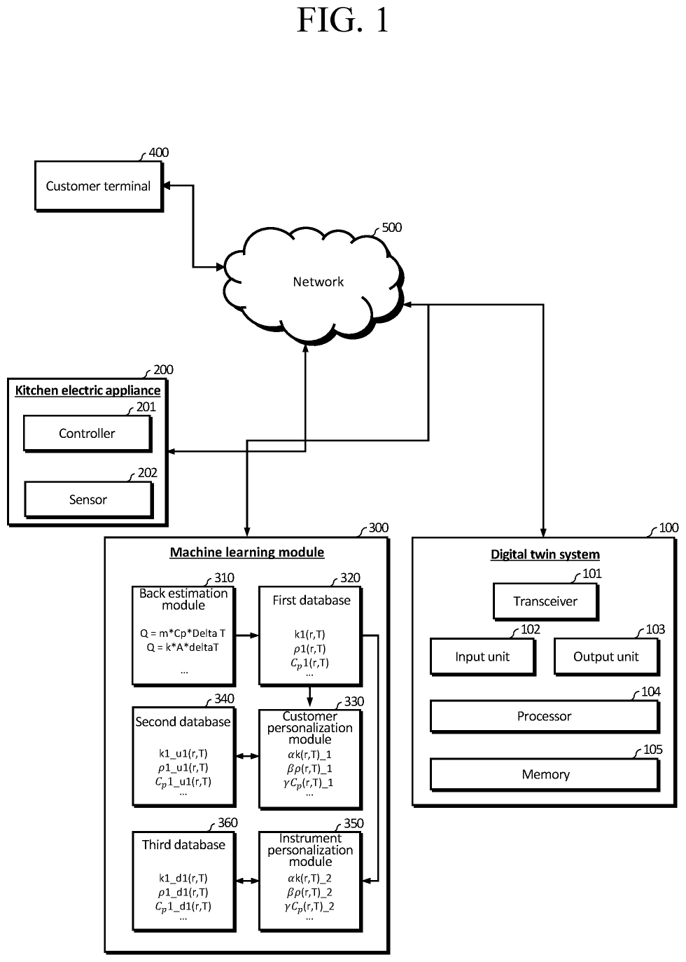

FIG. 1 is a block diagram specifically illustrating a relationship between a digital twin system 100 according to the present invention, a customer terminal 400, a kitchen appliance 200, and a machine learning module 300.

Referring to FIG. 1, the digital twin system 100 includes a transceiver 101, an input unit 102, an output unit 103, a processor 104, and an application which is read from a memory 105 and controlled by the processor 104.

The transceiver 101 may include a transmitter, a receiver, or a transceiver. The transceiver 101 may transmit and receive information to and from the customer terminal 400, the kitchen appliance 200, and the machine learning module 300 through the network 500.

The input unit 102 and the output unit 103 may be simultaneously configured as an input/output unit in the form of a touch display in a smartphone. The input unit 102 may include a physical keyboard device, a touch display, an image input sensor constituting a camera, a sensor for receiving a fingerprint, and a sensor for recognizing an iris. The output unit 103 may include a monitor, a touch display, etc. However, the present invention is not limited thereto, and the feature may include a keyboard, a mouse, a touch screen, and a monitor, a speaker, and the like, which are used as an input unit in a personal computer (PC), and the like. The input unit 102 receives a command from a user through the customer terminal 400. The output unit 103 outputs a result value under the control of the processor 104.

The processor 104 executes an overall control function of the terminal using programs and data stored in the memory 105 configured in the terminal. The processor 104 may include a random access memory (RAM), a read only memory (ROM), a central processing unit (CPU), a graphic processing unit (GPU), and a bus, and the RAM, the ROM, the CPU, the GPU, and the like may be connected to each other through the bus. The processor 104 may access the storage to perform booting using an operating system (O/S) stored in the memory 105, and may be configured to perform various operations described in the present disclosure while operating as an application unit using an application stored in the memory 105. The processor 104 may be configured to perform various embodiments disclosed in the present disclosure by controlling components in the device of the node, that is, the memory 105, the input unit 102, the output unit 103, the transceiver 101, and a camera (not shown).

The processor 104 executes an application using a program stored in the memory 105. The application may be controlled to receive target cooking condition data and real-time cooking target data from a kitchen appliance, specify a digital twin simulation based on the received target cooking condition data and real-time cooking target data, receive input data required for a heat transfer simulation from a machine learning module, and estimate an internal temperature value for monitoring a cooking process of a cooking target in real time.

The memory 105 may be configured as a database (DB) or various storage means such as a physical hard disk, a solid state drive (SSD), a web hard, etc.

The memory 105 stores an application that provides a function of receiving target condition cooking data from the kitchen appliance 200, receiving input data from the machine learning module 300, and forming a digital twin for a cooking target.

Further, the digital twin system 100 may include all kinds of handheld-based wireless communication devices that can be connected to an external server through a wireless communication network, such as a smart phone, a mobile phone, a personal digital assistant (PDA), a portable multimedia player (PMP), a tablet PC, and the like, and may also include a communication device that can be connected to an external server through a network, such as a IPTV including a desktop PC, a tablet PC, a laptop PC, and a set-top box.

Also, the digital twin system 100 may be implemented as a server operated by a service provider or an external company.

The kitchen appliance 200 includes an integrated kitchen utensil which cooks a cooking target by applying heat to electric appliances used in a kitchen. For example, the kitchen appliance 200 may include various kitchen appliances such as a light wave oven, a convection oven, a conventional oven, a cooktop, a microwave, an air fryer, an induction, a griller, a slow cooker, a hydraulic machine, a pressure cooker, a multi-cooker, a toaster, and the like.

The kitchen appliance 200 may include a controller 201 configured to control a cooking condition and a sensor 202 configured to collect real-time cooking target data.

The machine learning module 300 is a module that provides parameters necessary for constructing a digital twin in the digital twin system 100. The machine learning module 300 may include a back-estimation module 310, a first database 320, a customer personalization module 330, a second database 340, an instrument personalization module 350, and a third database 360.

The reverse estimation module 310 may estimate a heat transfer-related variable based on test data of the kitchen appliance. In addition, the reverse estimation module 310 may derive an estimate of the heat transfer-related variable based on an appropriate recipe for the cooking target.

Q=m*Cp*ΔT [Equation 1]

Q=k*A*ΔT [Equation 2]

Here, Q is a heat transferred amount, k is a thermal conductivity, m is a mass, Cp is a specific heat capacity, A is a heat transfer area, and ΔT is a difference in temperature.

The back estimation module 310 may estimate the remaining variables based on the Q and ΔT given in the test data of the kitchen appliance.

The inverse-estimation module 310 may derive ΔT with given k, Cp, and A values. The first database 320 may be a database that stores the heat transfer-related variable value derived from the reverse calculation module 310. The first database 320 may provide a heat transfer-related variable value to the digital twin system 100.

The customer personalization module 330 may process the variable of the first database 320 based on the taste review data on whether the cooking state desired by the customer is satisfied and update the variable in the second database 340.

The instrument individualization module 350 may process the variables of the first database 320 based on the review data for each cooking utensil according to the characteristic difference for each kitchen appliance and update the variables in the third database 360.

The customer terminal 400 may be an electronic device used by a user who wants to discharge waste. For example, the customer terminal 400 may include all kinds of handheld-based wireless communication devices, such as a smart phone, a mobile phone, a personal digital assistant (PDA), a portable multimedia player (PMP), and a tablet PC, which can be connected to an external server through a wireless communication network.

The network 500 may include a wired/wireless communication network such as a local area network (LAN), a wide area network (WAN), a virtual network, and remote communication.

It may include a wired/wireless communication network such as CK or remote communication.

An operation of the digital twin system 100 will be described as an example. The digital twin system 100 automatically calculates the amount of heat required for the cooking target to be cooked to the designated temperature. The digital twin system 100 measures a surface temperature Tp of an object required for a heat transfer equation in real time from a sensor 202 (for example, an infrared camera) installed in the kitchen appliance 200, and simultaneously estimates or receives a thickness Tp of the object. The digital twin system 100 identifies a cooking target through the sensor 202 or through direct input, and receives all internal input data values such as thermal conductivity (k), density (ρ), and heat capacity (Cₚ), which are required for calculating heat transfer according to the object, from the pre-defined databases 320, 340, and 360. Here, since the thermodynamic characteristics such as density are changed according to temperature, time, and location, the machine learning module 300 periodically updates the database defined in advance for the accuracy of the simulation. The digital twin system 100 provides a tool for monitoring a process of cooking through simulation and controlling a cooking temperature and time in real time by a user. The cooking target can be applied to all types of cooking foods such as eggs, steak, and rice that the user does not physically transform the cooking target during the cooking process. The equation used for the example is the thermal conductivity equation in the sphere, and this equation (1) is as follows. In addition, the initial value of the temperature should be applied together.

$$( \frac{1}{{r}^{2}} ) \frac{\partial }{\partial r} ( {kr}^{2} \frac{\partial T}{\partial r} ) + ( \frac{1}{{r}^{2} sin θ} ) \frac{\partial }{\partial θ} ( k sin θ \frac{\partial T}{\partial θ} ) + ( \frac{1}{{r}^{2} sin {θ}^{2}} ) \frac{k {\partial }^{2} T}{\partial {Φ}^{2}} + {\dot{Q}}_{g} = ρ {C}_{p} \frac{\partial T}{\partial t} \frac{\partial T}{\partial {r}_{( r = 0 )}} = 0 , {T}_{( r = R )} = {T}_{amb}$$

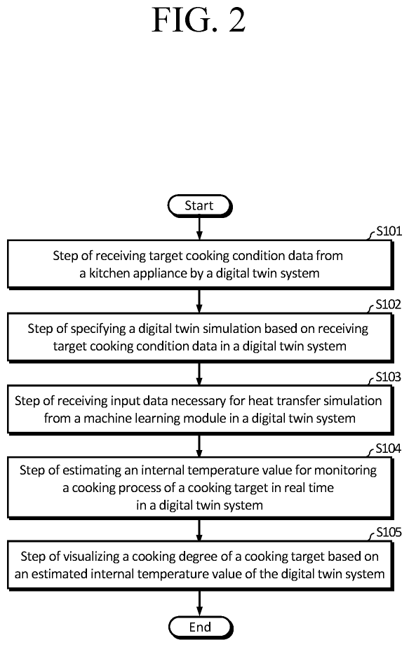

FIG. 2 is a flowchart illustrating a method for constructing a digital twin of a cooking target according to the present invention.

Referring to FIG. 2, the digital twin system includes a step S101 of receiving target cooking condition data and real-time cooking target data from a kitchen appliance, a step S102 of specifying, by the digital twin system, a digital twin simulation based on the received target cooking condition data and real-time cooking target data, a step S103 of receiving, by the digital twin system, input data required for a heat transfer simulation from a machine learning module, a step S104 of estimating, by the digital twin system, an internal temperature value for monitoring a cooking process of a cooking target in real time, and a step S105 of visualizing a cooking degree of the cooking target based on the estimated internal temperature value, by the digital twin system.

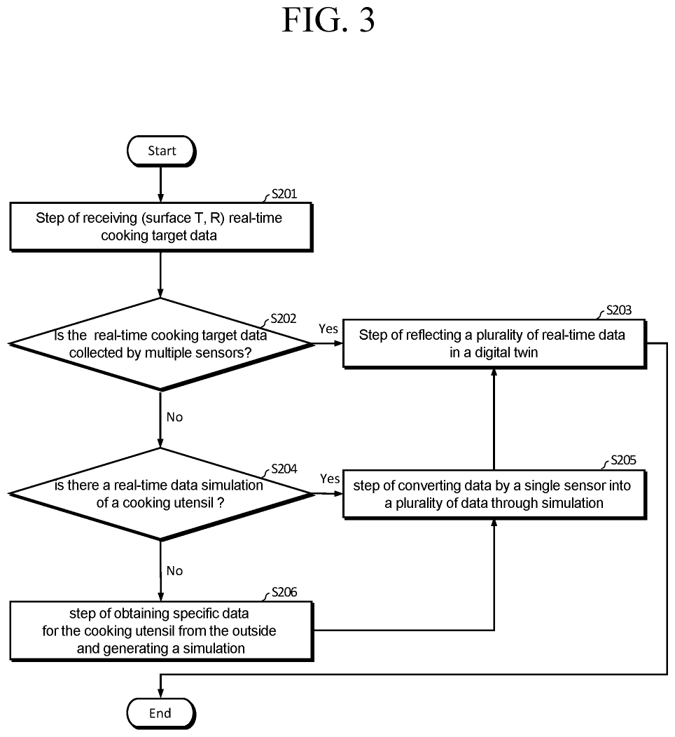

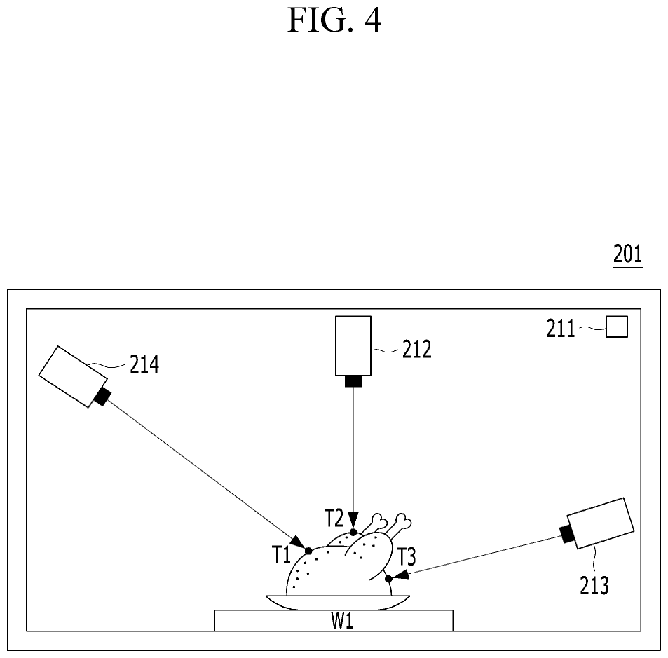

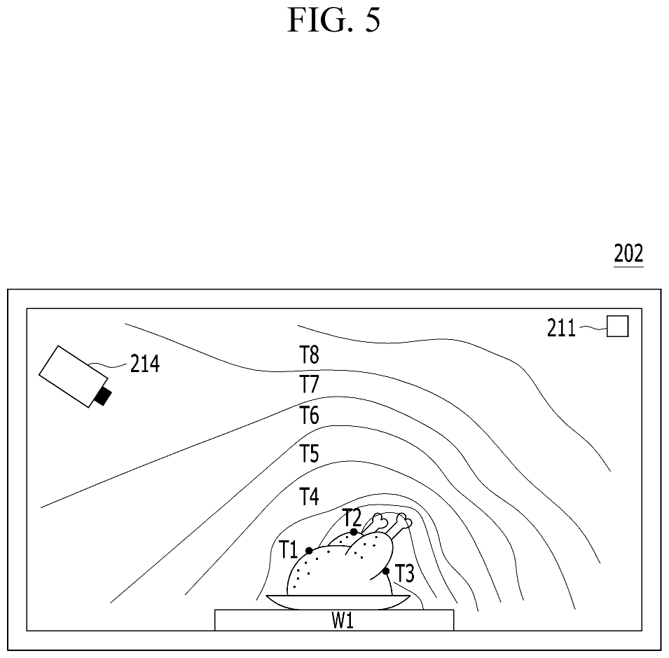

FIG. 3 is a flowchart illustrating a process of reflecting a plurality of real-time data in a digital twin simulation. FIG. 4 is a view illustrating sensing a surface temperature distribution of a cooking target based on a plurality of sensors. FIG. 5 is a diagram illustrating that the surface temperature distribution of a cooking target is estimated based on a simulation of one sensor and the cooking utensil.

Referring to FIG. 3, the method includes receiving real-time cooking target data of step S201, determining whether the real-time cooking target data is collected by a plurality of sensors of step S202, reflecting the plurality of real-time data to a digital twin of step S203, determining whether there is a real-time data simulation for a cooking utensil of step S204, converting the data for a single sensor into a plurality of data through the simulation of step S205, and obtaining characteristic data for the cooking utensil from the outside to generate the simulation of step S206.

Receiving the real-time cooking target data of step S201 may receive the real-time cooking target data (at least one piece of temperature data on the surface of the cooking target, the volume of the cooking target, and the average radius) from the kitchen appliance 200. Referring to FIGS. 4 and 5, the real-time cooking target data may be measured by the sensor 202 of the kitchen appliance 200. For example, referring to FIG. 4, a plurality of sensors 212, 213, and 214 for measuring the temperature of the surface of the cooking target may measure a plurality of temperatures T1, T2, and T3. The temperature data of the surface of the cooking target may be collected by the kitchen appliance 200 in real time and transmitted to the digital twin system 100. As the temperature distribution of the surface of the object to be cooked is checked as a whole, the completeness of the digital twin increases, so the presence of a plurality of sensors is preferable. However, since the number of sensors may be limited according to the kitchen appliance 200, the limit of the number of sensors may be deviated by estimating the overall surface temperature distribution based on one surface temperature distribution.

For example, referring to FIG. 5, since there is a single sensor 214 for sensing the surface temperature of the kitchen appliance 200, the corresponding sensor may sense only the temperature T1 of the first point on the surface of the cooking target. However, when the real-time data simulation of the kitchen appliance 200 is present, the precision of the digital twin may be improved by estimating the temperature T2 at the second point and the temperature T3 at the third point based on the temperature T1 at the first point based on the corresponding simulation. This may satisfy the precision of the digital twin which is much improved, rather than simply assuming that the temperature T1 at the first point is the temperature distribution of the entire cooking target.

Therefore, the step S202 may be performed as a step S203 of determining whether a plurality of sensors are collected by the kitchen appliance 200 and determining a surface temperature distribution based on a plurality of sensing contents when the plurality of sensors are provided, or may be performed as steps S204, S205, and S206 of improving precision of a digital twin through simulation when a single sensor is provided.

The method proceeds to step S204 of checking whether there is a real-time data simulation of the kitchen appliance, step S205 of converting data of a single sensor into a plurality of data through the simulation if there is the real-time data simulation, and step S206 of generating a simulation by obtaining characteristic data of the kitchen appliance from the outside if there is no real-time data simulation.

In the step S206 of generating the simulation, the real-time test data of the cooking target in the same cooking condition and the physical characteristics of the target kitchen appliance may be acquired from the outside to generate the simulation. For example, as illustrated in FIG. 5, the simulation may be a program that generates a temperature distribution gradient for estimating the remaining temperature points when one temperature point T1 is determined.

The step of converting the data by the single sensor into the plurality of data through the simulation of step S205 is a step of obtaining the surface temperature distribution of the cooking target through the simulation generating a temperature distribution gradient capable of estimating the remaining temperature points when one temperature point T1 is determined.

The reflecting of the plurality of real-time data to the digital twin of step S203 may include determining appearance information of the cooking target and determining internal information of the cooking target.

The determining of the appearance information of the cooking target may include determining mass, volume, three-dimensional appearance, and surface temperature distribution of the cooking target.

The determining of the internal information of the cooking target may be determining the internal information based on the identified basic information of the cooking target or determining the internal information based on the basic information of the cooking target input to the customer terminal or the kitchen appliance.

The determining of the internal information of the cooking target may be determining a composition, a density, and a layer structure of the inside of the cooking target.

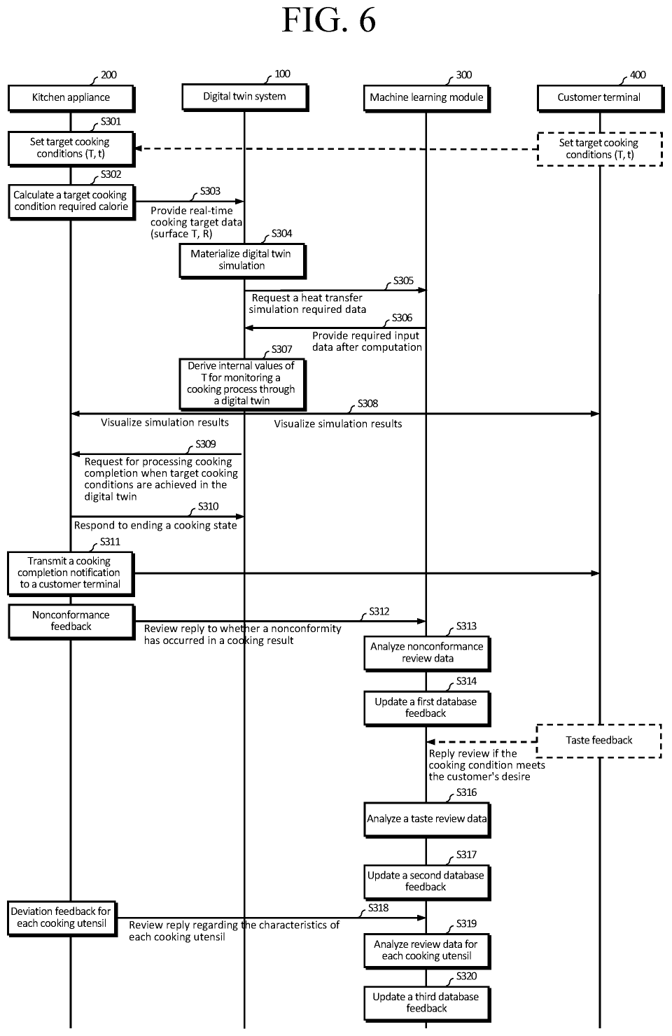

FIG. 6 is a diagram sequentially showing information exchanged between the digital twin system 100 according to the present invention and the customer terminal 400, the kitchen appliance 200, and the machine learning module 300.

Referring to FIG. 6, the target cooking condition may be set in the kitchen appliance 200 of step S301. The kitchen appliance 200 has its own input unit and controller so that the user may directly set the target cooking condition for the cooking target through the kitchen appliance 200, but the present invention is not limited thereto. The user may transmit the target cooking condition to the kitchen appliance 200 through a separate customer terminal 400 in a wired/wireless manner.

The kitchen appliance 200 may calculate a cooking condition-required calories of the cooking target based on the set target cooking condition of step S302. The step S302 of the necessary calories is performed by the controller 201 of the kitchen appliance 200, but is not limited thereto, and may be performed externally, for example, by the processor 104 of the digital twin system 100.

The kitchen appliance 200 may transmit real-time data (surface temperature, weight, volume, and radius) of the cooking target to the digital twin system 100 of step S303.

The digital twin system 100 may refine the digital twin simulation based on the transmitted real-time cooking target data of step S304. The specification of the digital twin simulation of step S304 may include, as described above with reference to FIG. 3, a step of determining whether real-time cooking target data is collected by a plurality of sensors, a step of reflecting the plurality of real-time data in the construction of the digital twin simulation when the real-time data is collected by the plurality of sensors, and a step of converting the plurality of real-time data into the plurality of data based on the real-time data simulation for the cooking utensil when the real-time data is collected by a single sensor and reflecting the plurality of real-time data in the construction of the digital twin simulation.

The digital twin system 100 may request the machine learning module 300 for data required for the heat transfer simulation of step S305 and receive the calculated required input data from the machine learning module of step S306.

As described above, the calculated necessary input data may be provided from the first database 320 in which the heat conduction function variables calculated through the back-estimation model 310 are stored, may be provided from the second database 330 in which the variables calculated by the customer personalization module 320 are stored, may be provided from a variable reflecting customer feedback, or may be provided from the third database 350 in which the variables calculated by the organization personalization module 340 are stored, may be provided from a variable reflecting deviation for each organization.

The digital twin system 100 may construct a digital twin based on the received variable and derive a key variable internal temperature (T) value for monitoring the cooking process of the cooking target in real time of step S307.

The digital twin system 100 outputs the constructed digital twin from the kitchen appliance 200 and/or the customer terminal 400 to allow the user to check the internal situation of the cooking target in real time of step S308.

When the target cooking condition is achieved in the digital twin system 100, the digital twin system 100 may transfer a cooking completion processing request to the kitchen appliance 200 of step S309, and the kitchen appliance 200 may process the completion of the cooking state according to the corresponding request and return the result to the digital twin system 100 of step S310.

The kitchen appliance 200 may transmit the cooking completion notification to the customer terminal 400 of step S311.

When the internal temperature of the cooking target on the digital twin and the actual internal temperature of the cooking target are different from each other by a predetermined value or more or when abnormality of other cooking occurs, the kitchen appliance 200 generates unsuitable review data and transmits the unsuitable review data to the machine learning module 300. The machine learning module 300 may analyze the nonconformance review analysis data of step S313 to feedback update the variables of the first database of step S314.

In the customer terminal 400, even though there is no problem in actual cooking, when the user wants to update the taste of each individual due to a deviation between the simulation on the digital twin and the actual cooking result of the cooking target, the user may feedback the taste review data of step S315. The machine learning module 300 may analyze the taste review analysis data of step S316 to feedback update the variables of the second database of step S317.

When a deviation occurs in the kitchen appliance 200 according to characteristics of each cooking utensil, review data for each cooking utensil is generated and transmitted to the machine learning module 300. The machine learning module 300 may analyze the review data for each cooking tool of step S319 to feedback update the variables of the third database of step S320.

Although not shown in the drawings, the digital twin system 100 may convert input data values of the first to third databases from the machine learning module 200 in a predetermined manner and receive the converted input data values.

The conversion into the predetermined scheme may be conversion based on a first weight applied to the variable value of the first database, a second weight applied to the variable value of the second database, and a third weight applied to the variable value of the third data.

For example, the conversion scheme may be configured as follows.

k1_{modified(r,t)}=wt₁×k1(r,t)+wt2×ku1(r,t)+wt3×kd1(r,t)

Here, k1_{modified(r,t)} are variables converted by a predetermined conversion method, where wt1 is a first weight, wt2 is a second weight, wt3 is a third weight, k1(r, t) is a first database variable value, ku1(r, t) is a second database variable value, and kd1(r, t) is a third database variable value.

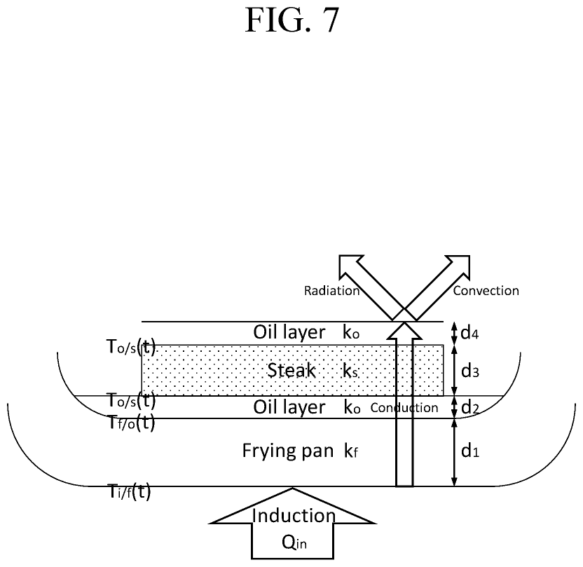

FIG. 7 is a diagram illustrating an example of a heat conduction analysis of a cooking target that is cooked in an induction oven.

With reference to FIG. 7, the construction of a digital twin when the cooking tool is a frying pan and the cooking target is a steak, and the calculation of the heat conduction function will be described in detail below.

In FIG. 7, it is assumed that k represents thermal conductivity, subscripts o, s, f, and i respectively represent oil, steak, frying pan, and induction, and respective thermal conductivity values are equations according to known parameters or temperatures. Further, d₁, d₄ denotes the thickness of each layer and T_{s/o}, T_{o/s}, T_{f/o}, T_{i/f} denotes the temperature of the boundary between two subscripts.

TABLE 1

| Frying pan | | Oil layer | | Steak | |
|---|---|---|---|---|---|
| * | ${\dot{q}}_{in} = \frac{{Q}_{in} \text{?} transfer rate}{Bottom surface area}$ | * | $- {k}_{f} \frac{\partial {T}_{f} ( {d}_{1} , t )}{\partial h} \text{?} rate = - {k}_{o} \frac{\partial \text{?} ( {d}_{1} , t )}{\partial h}$ | * | $- {k}_{o} \frac{\partial \text{?} ( {d}_{1} + {d}_{2} , t )}{\partial h} = - {k}_{s} \frac{\partial {T}_{s} ( {d}_{1} + {d}_{2} , t )}{\partial h}$ |
| * | ${\dot{q}}_{in} = - {k}_{f} \frac{\partial {T}_{f} ( 0 , t )}{\partial h}$ | * | $- {k}_{o} \frac{\partial \text{?} ( {d}_{1} , t )}{\partial h} = {k}_{o} \frac{\partial \text{?} ( {d}_{1} + {d}_{2} , t )}{\partial h}$ | * | $- {k}_{s} \frac{\partial {T}_{s} ( {d}_{1} + {d}_{2} , t )}{\partial h} = - {k}_{s} \frac{\partial {T}_{s} ( {d}_{1} \sim {d}_{2} , t )}{\partial h}$ |
| * | $- {\dot{q}}_{in} = - {k}_{f} \frac{\partial {T}_{f} ( {d}_{1} , t )}{\partial h}$ | | | ^{#} | $\frac{\partial }{\partial z} ( {k}_{s} \frac{\partial {T}_{s} ( h , t )}{\partial h} ) = ρ {C}_{p} \frac{\partial {T}_{s} ( h , t )}{\partial t}$ |
| ^{@} | T_{i/f}(t) = T_{f}(0, t) T_{f/o}(t) = T_{f}(d₁, t) = [symbol] (d₁, t) | ^{@} | T_{o/s}(t) = Tₒ(d₁~d₂, t) = Tᵢ(d₁~d₂, t) | ^{@} | T_{s/o}(t) = Tₛ(d₁~d₂, t) = Tₒ(d₁~d₂, t) |

[symbol]

indicates data missing or illegible when filed

Only a certain transfer rate of the heat Qᵢₙ generated in the induction is transferred to the frying pan as a heat flow per area (qᵢₙ), and only a certain transfer rate of the heat flow per area is transferred to the oil layer again. In addition, it is assumed that all heat flows per area transferred to the are transferred to the stator. In Table 1, a region marked with * indicates a conditional expression at a boundary, a # region indicates an internal temperature gradient of an object, and an @ region indicates each boundary.

The temperature gradient data inside the stake obtained through this is shaped in the frying pan. Through the screen attached to the handle, it is possible to directly check the internal temperature Tₛ(h,t) of the steak through the kitchen appliance 200 or the customer terminal 400, rather than the degree of ripening of the unseen food. It can be cooked while checking in real time.

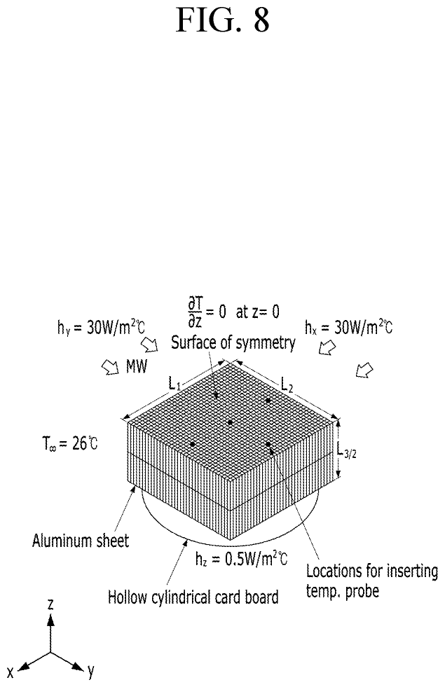

FIG. 8 is a view illustrating an example of the heat conduction analysis of a cooking target cooked in a microwave oven.

Referring to FIG. 8, the construction of a digital twin in a case where the cooking utensil is a microwave oven and the calculation of a thermal conduction function will be described in detail below.

The heat input flow diagram in the microwave oven has the following assumptions. It is assumed that the average loss of moisture content during thawing in a microwave oven is less than 1% and is ignored. In addition, it is assumed that the target food is homogeneous and has a constant density during the thawing process. The Cₚₐ as measured apparent specific heat used in the simulation of the thawing process contains the latent heat in the phase change. In addition to the equation (1) mentioned above, equations Q′_{g} (heat generation) and (heat loss due to evaporation) for i (Zeng & Faghri, 1994) can be summarized simply as follows. Here, δ represents the microwave transmission depth in the x, y, and z axes, respectively, and F represents convective heat.

$$\frac{\partial }{\partial x} ( k \frac{\partial T}{\partial x} ) + \frac{\partial }{\partial y} ( k \frac{\partial T}{\partial y} ) + \frac{\partial }{\partial z} ( k \frac{\partial T}{\partial z} ) + {\dot{Q}}_{g} - \dot{I} = ρ {C}_{pa} \frac{\partial T}{\partial t}$$

$${\dot{Q}}_{g} = \frac{F}{{δ}_{x}} [ exp ( - {\int }_{\frac{{L}_{1}}{2}}^{x} \frac{dx}{{δ}_{x}} ) + exp ( - {\int }_{x}^{\frac{{L}_{1}}{2}} \frac{dx}{{δ}_{x}} ) ]$$

$$i = ( \begin{matrix}0 when T < 100 ° C \\ Q when T > 100 ° C\end{matrix} )$$

Simulation of the defrosting process should also specify temperature boundary conditions and initial conditions, and the conditions may be arranged as follows, similar to the aforementioned example.

$$T ( t = 0 ) = {T}_{i}$$

$$\frac{δ T}{δ x} {\vert}_{x = 0} = 0 , \frac{δ T}{δ y} {\vert}_{y = 0} = 0 , \frac{δ T}{δ z} {\vert}_{z = 0} = 0$$

$$- k \frac{\partial T}{\partial x} {\vert}_{x = \pm {L}_{1 / 2}} = {h}_{x} ( T - {T}_{∞} ) , - k \frac{\partial T}{\partial y} {\vert}_{x = \pm {L}_{2 / 2}} = {h}_{y} ( T - {T}_{∞} ) , - k \frac{\partial T}{\partial z} {\vert}_{z = \pm {L}_{3 / 2}} = {h}_{z} ( T - {T}_{∞} )$$

The temperature value T(x, y, z, t) and the thawing time (t when T(0, 0, 0, t)=0) of the food calculated through the simulation process may be directly checked through the kitchen appliance 200 or checked through the customer terminal 400.

Exemplary embodiments have been disclosed in the drawings and in the specification as described above. Although embodiments have been described using specific terms in the present specification, they are used only for the purpose of describing the technical spirit of the present disclosure, and are not used to limit the meaning or limit the scope of the present disclosure described in Claims. Therefore, those skilled in the art will understand that various modifications and other equivalent embodiments are possible therefrom. Therefore, the true technical protection scope of the present disclosure should be determined by the technical idea of the appended claims.

What is claimed is:

1. A method of constructing a digital twin of a cooking target linked with kitchen appliance, the method comprising:
receiving, by a digital twin system, real-time cooking target data from the kitchen appliance;
implementing, by the digital twin system, a digital twin simulation based on the received real-time cooking target data;
receiving, by the digital twin system, input data required for a heat transfer simulation from a machine learning module; and
estimating, by the digital twin system, an internal temperature value for monitoring a cooking process of the cooking target in real time.

2. The method of claim 1, wherein the real-time cooking target data includes at least one piece of temperature data of a surface of the cooking target, a volume of the cooking target, and an average radius.

3. The method of claim 1, wherein the implementing the digital twin simulation comprises:
determining whether real-time data to be cooked is collected by a plurality of sensors;
when the real-time data is collected by the plurality of sensors, reflecting the plurality of real-time data in the construction of the digital twin simulation; and
when the real-time data is collected by a single sensor, converting the real-time data into a plurality of data based on the real-time data simulation for a cooking utensil and reflecting the plurality of real-time data in the construction of the digital twin simulation.

4. The method of claim 3, wherein the converting into the plurality of data based on the real-time data simulation further includes acquiring characteristic data of the cooking utensil from outside and generating a simulation.

5. The method of claim 3, wherein the reflecting of the plurality of real-time data in the digital twin simulation construction comprises:
determining appearance information of the cooking target; and
determining internal information of the cooking target.

6. The method of claim 5, wherein the determining of the appearance information of the cooking target comprises determining a mass, a volume, a three-dimensional appearance, and a surface temperature distribution of the cooking target.

7. The method of claim 5, wherein the determining of the internal information of the cooking target is determined based on identified basic information of the cooking target or is determined based on the basic information of the cooking target input to a customer terminal or the kitchen appliance.

8. The method of claim 5, wherein the determining of the internal information of the cooking target comprises determining a composition, a density, and a layer structure of inside of the cooking target.

9. The method of claim 1, wherein the receiving of the input data required for the heat transfer simulation is receiving a variable value required for a heat conduction function.

10. The method of claim 9, wherein a value of a variable required for the heat conduction function is obtained from a first database obtained through a back estimation module.

11. The method of claim 10, further comprising:
receiving inappropriate review data based on a deviation between the digital twin simulation and an actual cooking result from a customer terminal or the kitchen appliance; and
feedback-updating a variable value required for a heat conduction function of the first database.

12. The method of claim 9, wherein a variable value required for the heat conduction function is obtained from a second database obtained through a customer personalization module.

13. The method of claim 12, further comprising:
receiving taste review data based on a cooking state intended by a customer through a customer terminal; and
feedback-updating a variable value required for a heat conduction function of the second database.

14. The method of claim 9, wherein a variable value required for the heat conduction function is obtained from a third database obtained through a cooking tool individualization module.

15. The method of claim 14, further comprising:
receiving review data for each cooking tool based on a deviation for each cooking tool from the kitchen appliance; and
feedback-updating a variable value required for a thermal conductivity function of the third database.

16. The method of claim 1, wherein in the receiving of the input data necessary for the heat transfer simulation, a variable value necessary for a heat conduction function is provided from at least one of a first database obtained through a back-estimation module, a variable value necessary for the heat conduction function is obtained through a customer personalization module, and a variable value necessary for the heat conduction function is provided from at least one of a third database obtained through a cooking utensil personalization module, or the input data values of the first to third databases are converted into a predetermined manner and received.

17. The method of claim 16, wherein the conversion into the predetermined manner is performed based on a first weight applied to the variable value of the first database, a second weight applied to the variable value of the second database, and a third weight applied to the variable value of the third data.

18. The method of claim 1, further comprising, after the estimating of the internal temperature value, when the internal temperature of the digital twin reaches a target cooking condition, requesting the kitchen appliance to complete cooking.

19. A digital twin system, comprising:
a transceiver capable of transmitting and receiving information to and from a customer terminal, a kitchen appliance, and a machine learning module through a network;
a memory storing an application for receiving target condition cooking data from the kitchen appliance and receiving input data from the machine learning module to form a digital twin for a cooking target;
a processor for reading and controlling the application from the memory;
an input unit for receiving instructions from a user through the customer terminal; and
an output unit for outputting a result value under the control of the processor,
wherein the application enables the digital twin system to receive target cooking condition data and real-time cooking target data from the kitchen appliance, enables the digital twin system to materialize a digital twin simulation based on the received target cooking condition data and real-time cooking target data, enables the digital twin system to receive input data required for a heat transfer simulation from the machine learning module, and enables the digital twin system to estimate an internal temperature value for monitoring a cooking process of the cooking target in real time.
